(19) United States
(12) Patent Application Publication
(10) Pub. No.: US 2004/0239082 A1
(43) Pub. Date: Dec. 2, 2004

(54) Overhead airbag system

(76) Inventors: David W. Schneider, Waterford, MI (US); David L. Dominissini, Allen Park, MI (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/449,837

(22) Filed: May 30, 2003

(51) Int. Cl. B60R 21/22; B60R 21/26

(52) U.S. Cl. 280/730.1; 280/736

(57) ABSTRACT

The overhead airbag system includes an inflator, a rigid tube, and an inflatable cushion, which may include a recess. The inflator is in fluid communication with the rigid tube. The tube includes one or more gas exit apertures. The inflatable cushion includes an opening in which the tube is positioned such that the aperture or apertures are positioned within the cushion. The inflator and rigid tube are attachable to a vehicle in a generally linear configuration to enable the overhead airbag system to be installed in the tight confines between the roof and ceiling liner of a vehicle, even in the presence of a sun or moon roof. The pattern and shape of the apertures in the rigid tube may be modified to alter how gas is distributed within the cushion during inflation.

### BACKGROUND OF THE INVENTION

1. Field of the Invention

The present invention relates to an airbag system designed to protect an occupant of a vehicle during a collision. More specifically, this invention relates to a system for protecting an occupant of a vehicle using an overhead airbag system.

2. Description of Related Art

Inflatable airbags are well accepted for use in motor vehicles and have been credited with preventing numerous deaths and injuries. Some statistics estimate that frontal airbags reduce the fatalities in head-on collisions by 25% among drivers using seat belts and by more than 30% among unbelted drivers. Statistics further suggest that with a combination of a seat belt and an airbag, serious chest injuries in frontal collisions can be reduced by 65% and serious head injuries by up to 75%. Airbag use presents clear benefits and vehicle owners are frequently willing to pay the added expense for airbags. In addition, the inclusion of inflatable safety restraint devices, or airbags, is now a legal requirement for many new vehicles.

Airbag systems typically include three principal components: an electronic control unit (ECU), an inflator, and an inflatable cushion. The ECU monitors the acceleration and deceleration of the vehicle and determines when accident conditions exist. The ECU is in communication with the inflator and transmits a signal to the inflator when the ECU determines that the vehicle has been involved in an accident.

In response to receipt of the signal, the inflator generates inflation gas. The inflator can be designed to produce inflation gas using various methods. For instance, the inflator may use pyrotechnic techniques or simply release compressed gas. In addition, the inflator may use a combination of both pyrotechnics and compressed gas to produce pressurized inflation gas. The inflator is in fluid communication with the inflatable cushion.

The inflatable cushion receives the gas generated by the inflator and rapidly expands as the gas fills the cushion. The inflatable cushion is made from a flexible material, such as fabric. When expanded, the cushion receives the energy of an occupant impact and dissipates the energy such that injuries are minimized or completely avoided.

The positioning of the inflated cushion during a crash is critical to proper protection of an occupant. The inflated cushion should be positioned to shield the occupant from impacting hard surfaces within the vehicle, such as the steering wheel, windshield, or dashboard.

The most common type of airbag system stores the cushion and inflator in a compartment in the steering wheel. This type of airbag system is frequently referred to as a driver's side airbag system. When the vehicle is involved in an accident, the ECU, which is generally not situated in the steering wheel, sends a signal to the inflator. The cushion receives the gas generated by the inflator, expands, and is propelled out of the compartment in the steering wheel. The cushion is fully inflated in a fraction of a second. The inflated cushion prevents the driver from striking the steering wheel and dissipates the kinetic energy of the occupant to minimize injury to the occupant. Similar airbag systems are frequently installed in the passenger side of the dashboard. Unfortunately, these types of airbag systems have several disadvantages including poor protection for out-of-position (OOP) occupants and unaesthetic tear seams on the instrument panel or steering wheel.

Overhead airbags systems have been produced in an attempt to provide better protection for out-of-position vehicle occupants and to avoid the necessity of installing airbags in the steering wheel or dashboard of a vehicle. These airbag systems are stored in a compartment in the roof of a vehicle. When accident conditions exist, the cushion deploys down and away from the roof to a position in front of a protected occupant. The cushion prevents the occupant from striking the dashboard or windshield of the vehicle.

Unfortunately, conventional overhead airbag systems suffer from a number of limitations. In particular, one problem that continues to affect the overhead airbag system is the limited space between the roof and ceiling liner of a vehicle in which the overhead airbag system is installed. Moreover, the space constraints become even more severe when the vehicle in question has a sun or moon roof.

To address this problem, many conventional overhead airbag systems place the inflator in a location that is remote to the overhead cushion. Remote placement of the inflator, however, introduces additional problems and costs to the system. For instance, reliable and rapid transmission of the inflation gas to the cushion becomes an issue. Also, installing this type of overhead airbag system in a vehicle can be complex, time-consuming, and expensive because multiple areas of the vehicle or the system may need to be modified to permit successful installation.

In addition, the limited space available to overhead airbag systems makes it difficult to control and properly distribute inflation gas transmitted into the cushion. Injecting the inflation gas into a single opening in the inflatable cushion can result in lopsided or uneven inflation of the cushion. In addition, injecting the inflation gas through multiple openings in the cushion can be complex and expensive.

Conventional overhead airbag systems often suffer from another limitation. During occupant loading, the cushion may be tethered to a position behind the occupant's head. As a result, the occupant's head and neck may rotate backward relative to the occupant's body as the occupant impacts the cushion, potentially placing stress on the occupant's neck.

Accordingly, there is a need in the art for a novel airbag system that addresses one or more of the above-listed problems. Such a device is disclosed herein.

### SUMMARY OF THE INVENTION

The apparatus of the present invention has been developed in response to the present state of the art, and in particular, in response to problems and needs in the art that have not yet been fully solved by currently available airbag systems. The overhead airbag system resolves these concerns in that it is compact and can easily fit between the roof and ceiling liner of a vehicle, even when a moon or sun roof is present. Moreover, the overhead airbag system provides a technique for effectively controlling the distribution of inflation gas injected into the inflatable cushion.

The overhead airbag system includes an electronic control unit (ECU), an inflator, a gas guide, a rigid tube, and a cushion. The ECU monitors the acceleration and deceleration of the vehicle and determines when accident conditions exist. The ECU is in communication with the inflator using, for example, wiring. When accident conditions exist, the ECU transmits a signal through the wiring to the inflator. The inflator generates gas for inflating the cushion. Those skilled in the art will recognize that the ECU and inflator may be embodied in a number of different ways within the scope of this invention. For example, in an alternative embodiment, two or more inflators may be used to inflate the cushion.

The gas guide is a conduit that places the inflator in fluid communication with the tube such that pressurized gas produced by the inflator travels from the inflator to the tube. The gas guide is coupled to the inflator and the tube using, for example, clamps. The gas guide may be made from flexible tubing to enable repositioning of the inflator and tube relative to each other during the installation process. In an alternative embodiment, the gas guide is omitted, and the inflator is connected directly to the tube.

The rigid tube includes a first end, a second end, and a lateral portion. The first end is open and is attached to the gas guide using a clamp. Alternative techniques, such as ultrasonic welding, may be used to secure the gas guide to the tube. The second end of the tube is closed. The tube is made from a rigid material, such as steel or a hard polymer.

The tube has one or more gas exit apertures. The apertures may be positioned on the lateral portion of the tube. At least a portion of the tube is situated within the cushion such that the apertures are positioned within the cushion. The pattern of the apertures controls the way in which pressurized gas enters the cushion and thus influences the shape of the cushion during the inflation process.

As will be understood by those skilled in the art, the apertures may be arranged in a number of different patterns within the scope of this invention. For example, the apertures may be arranged in a linear, zigzag, symmetrical, or nonsymmetrical pattern. Alternatively, a single elongated aperture may be used. In addition, the shape of the apertures may also be varied. Thus, the apertures may have, for instance, a round, square, rectangular, elliptical, or non-symmetrical shape.

The cushion is made from a flexible material, such as fabric, and is designed to rapidly expand in response to the receipt of pressurized inflation gas. The shape of the cushion, in its inflated condition, may also be varied. For example, the cushion may have a generally round or teardrop shape. Alternatively, the cushion may have a generally flat or elongated shape. The cushion may be embodied as an overhead cushion, which is designed to deploy in a generally downward direction from a position above an occupant of a vehicle.

The cushion has a first opening and a second opening. The first end of the tube is positioned within the first opening, and the second end of the tube is positioned within the second opening. A pair of clamps can be used to secure the tube within the cushion. Alternatively, adhesives, rivets, crimping, or other known techniques can be used to secure the tube within the cushion. As stated above, the apertures of the tube are positioned within the cushion. In an alternative embodiment, the cushion may have only one opening through which the tube is inserted.

In one embodiment, the overhead airbag system has a recessed cushion. The recessed cushion includes a gas delivery conduit, a main body, and a bulge that form a recess when the cushion is inflated. The conduit serves as a passage through which gas moves from the tube into the main body of the recessed cushion. Opposing portions of the conduit are secured to each other to diminish the overall size of the conduit. The conduit also supports the main body to ensure proper positioning of the recessed cushion during inflation.

The main body is in fluid communication with the conduit and bulge of the recessed cushion. The main body receives the occupant's torso during loading and thus prevents the occupant from striking the dashboard and windshield in the event of an accident.

The bulge of the recessed cushion extends away from the main body towards a roof of the vehicle and towards the occupant when the cushion is inflated. The bulge is positioned on the recessed cushion to receive the occupant's head and neck during an accident.

The conduit, main body, and bulge define a recess when the cushion is inflated. When the recessed cushion is inflated and installed to protect an occupant seated in the front seat of the vehicle, the recess is interposed between the main body and the bulge, and the main body is disposed closer to the windshield than the main body. As a result, when the occupant's head impacts the bulge, the recess enables the bulge to move toward the windshield of the vehicle and more gradually decelerate the occupant's head and neck. The recess thus diminishes the possibility that the occupant's head and neck will contort towards the seat, relative to the occupant's torso, as the occupant's torso impacts the main body of the cushion.

A first bracket, which is secured to the inflator, is used to attach the inflator to a vehicle. A second bracket is attached to the clamps that secure the tube within the cushion. The first and second brackets are attached to the vehicle. Various techniques, such as heat or pressure welding, brazing, adhesives, screws, bolts, or rivets, may also be employed to secure the overhead airbag system to the vehicle. The overhead airbag system can be attached to various parts of the vehicle, including a header or lateral rail of a vehicle.

When attached to a vehicle, the inflator, gas guide, and tube are positioned in a generally linear configuration. In one embodiment, the longitudinal axes of the inflator, gas guide, and tube are generally arranged in a line. However, the term “generally linear configuration,” as used in this application, does not mean that the inflator, gas guide, and tube are positioned precisely in a line. Thus, there may be some angling of the inflator, gas guide, and tube relative to each other within the scope of this invention. This generally linear configuration of the inflator, gas guide, and tube enables the overhead airbag system to fit within the tight confines between a roof and ceiling liner of a vehicle, even when a sun or moon roof is present in the vehicle.

The overhead airbag system operates in the following manner. The ECU produces a signal when it determines that accident conditions exist. The signal travels through the wiring. In response to receipt of the signal, the inflator generates pressurized inflation gas. The inflation gas travels through the gas guide and into the tube. Thereafter, the inflation gas is forced through the apertures of the tube into the cushion. In response to receipt of the inflation gas, the cushion expands until it is fully inflated.

The overhead airbag system thus provides substantial advantages over conventional airbag systems. The overhead airbag system is compact in that the inflator, gas guide, and rigid tube are arranged in a generally linear configuration. Accordingly, the overhead airbag system may be installed in the tight confines between the ceiling liner and roof of a vehicle. In addition, using the rigid tube with apertures, the overhead airbag system provides a simple yet effective mechanism for diffusing and controlling the flow of gas into the cushion. More specifically, the pattern and shape of the apertures in the rigid tube may be modified to alter how gas is distributed within the cushion during inflation. In addition, the recessed cushion provides enhanced cushion positioning during inflation, which results in superior protection to the head and neck of the occupant.

These and other features, and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and features of the invention are obtained, a more particular description of the invention summarized above will be rendered by reference to the appended drawings. Understanding that these drawings illustrate only selected embodiments of the invention and are not therefore to be considered limiting in scope, the invention will be described and explained with additional specificity and detail through the use of the accompanying drawings in which:

FIG. 1 is a perspective view of a first embodiment of the overhead airbag system in an inflated condition;

FIG. 2 is a bottom view of the first embodiment of the overhead airbag system installed in a vehicle with a portion of the ceiling liner of the vehicle cutaway;

FIG. 3 is a side view of the first embodiment of the overhead airbag system in a vehicle with the cushion shown in an inflated condition;

FIG. 4 is a perspective view of a second embodiment of the overhead airbag system in a stowed condition;

FIG. 5 is a perspective view of a third embodiment of the overhead airbag system that includes a recessed cushion shown in an inflated condition; and

FIG. 6 is a side view of the third embodiment of the overhead airbag system in a vehicle with the recessed cushion shown in an inflated condition.

### DETAILED DESCRIPTION OF THE PREFERRED EMBODIMENTS

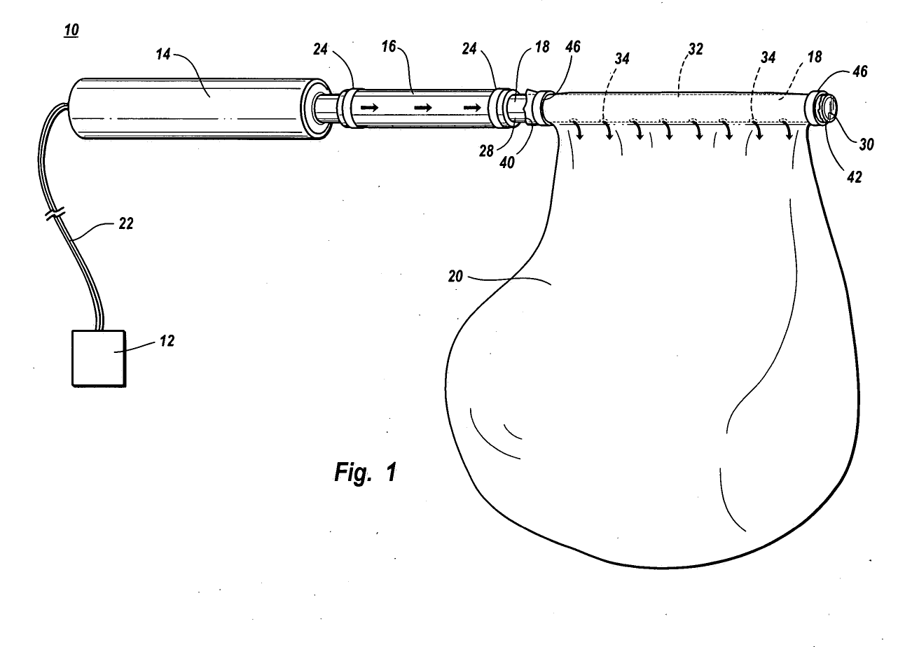

The preferred embodiments of the invention are now described with reference to FIGS. 1-6, wherein like parts are designated by like numerals throughout. The members of the present invention, as generally described and illustrated in the Figures, may be designed in a wide variety of configurations. Thus, the following more detailed description of the embodiments of the present invention, as represented in the Figures, is not intended to limit the scope of the invention, as claimed, but is merely representative of presently preferred embodiments of the invention.

FIG. 1 is a perspective view of a first embodiment of the overhead airbag system 10 in an inflated condition. In overview, the system 10 includes an electronic control unit (ECU) 12, an inflator 14, a gas guide 16, a rigid tube 18, and a cushion 20.

The ECU 12 monitors the acceleration and deceleration of a vehicle and determines when accident conditions exist. The ECU 12 is in communication with the inflator using, for example, the wiring 22 shown in FIG. 1. When accident conditions exist, the ECU 12 transmits a signal through the wiring 22 to the inflator 14. The inflator 14 generates gas for inflating the cushion 20. Those skilled in the art will recognize that the ECU 12 and inflator 14 may be configured in a number of different ways within the scope of this invention. For example, in an alternative embodiment, a plurality of inflators 14 may be used to inflate the cushion 20.

As shown, the gas guide 16 is coupled to the inflator 14 and tube 18 using clamps 24. As will be understood by those of skill in the art, alternative techniques, such as the use of adhesives, rivets, or crimping, may be employed to secure the gas guide 16 to the inflator 14 and tube 18.

The gas guide 16 is a conduit that places the inflator 14 in fluid communication with the tube 18 such that pressurized gas produced by the inflator 14 travels from the inflator 14 to the tube 18. The gas guide 16 may be made from flexible tubing to enable repositioning of the inflator 14 and tube 18 relative to each other during the installation process. In an alternative embodiment, the gas guide 16 is omitted, and the inflator 14 is connected directly to the tube 18.

The rigid tube 18 includes a first end 28, a second end 30, and a lateral portion 32. The first end 28 is open and is attached to the gas guide 16 using a clamp 24. The second end 30 is closed. The tube 18 is made from a rigid material, such as steel or a hard polymer.

The tube 18 has one or more gas exit apertures 34 in the lateral portion 32 of the tube 18. The apertures 34 are positioned within the cushion 20. The pattern of the apertures 34 controls the way in which pressurized gas enters the cushion 20 and thus influences the shape of the cushion 20 during the inflation process.

The apertures 34 are shown in a linear configuration in FIG. 1. However, as will be understood by those skilled in the art, the apertures 34 may be arranged in a number of different patterns within the scope of this invention. For example, the apertures 34 may be arranged in an offset or zigzag pattern. Alternatively, a single elongated aperture 34 may be used. In addition, the shape of the apertures 34 may also be varied within the scope of this invention. Thus, the apertures 34 may have, for instance, a round, square, rectangular, elliptical, or non-symmetrical shape.

The cushion 20 is made from a flexible material, such as fabric, and is designed to rapidly expand in response to the receipt of pressurized inflation gas. Those skilled in the art are familiar with the materials from which cushions 20 may be made. The shape of the cushion 20, in its inflated condition, may also be varied. For example, the cushion 20 may have a generally round or teardrop shape. Alternatively, the cushion 20 may have a generally flat or elongated shape. As illustrated, the cushion 20 may be embodied as an overhead cushion 20, which is designed to deploy in a generally downward direction from a position above an occupant of a vehicle.

The cushion 20 has a first opening 40 and a second opening 42 positioned on opposing sides thereof. The first end 28 of the tube 18 is positioned within the first opening 40, and the second end 30 of the tube 18 is positioned within the second opening 42. A pair of clamps 46 can be used to secure the tube 18 within the openings 40, 42 of the cushion 20. Alternatively, adhesives, rivets, crimping, or other known techniques can be used to secure the tube 18 within the cushion 20. As stated above, the apertures 34 of the tube 18 are positioned within the cushion 20.

In an alternative embodiment, the cushion 20 may have only one opening 40 through which the tube 18 is inserted. In this embodiment, only one clamp 46 may be required or an open-ended clamp (not shown), for example, may be used to secure the second end 30 of the tube 18 within the cushion 20.

The overhead airbag system 10 operates in the following manner. The ECU 12 produces a signal when it determines that accident conditions exist. The signal travels through the wiring 22. In response to receipt of the signal, the inflator 14 generates pressurized inflation gas. The inflation gas travels through the gas guide 16 and into the tube 18. Thereafter, the inflation gas is forced through the apertures 34 of the tube 18 into the cushion 20. In response to receipt of the inflation gas, the cushion 20 expands until it is inflated as shown in FIG. 1.

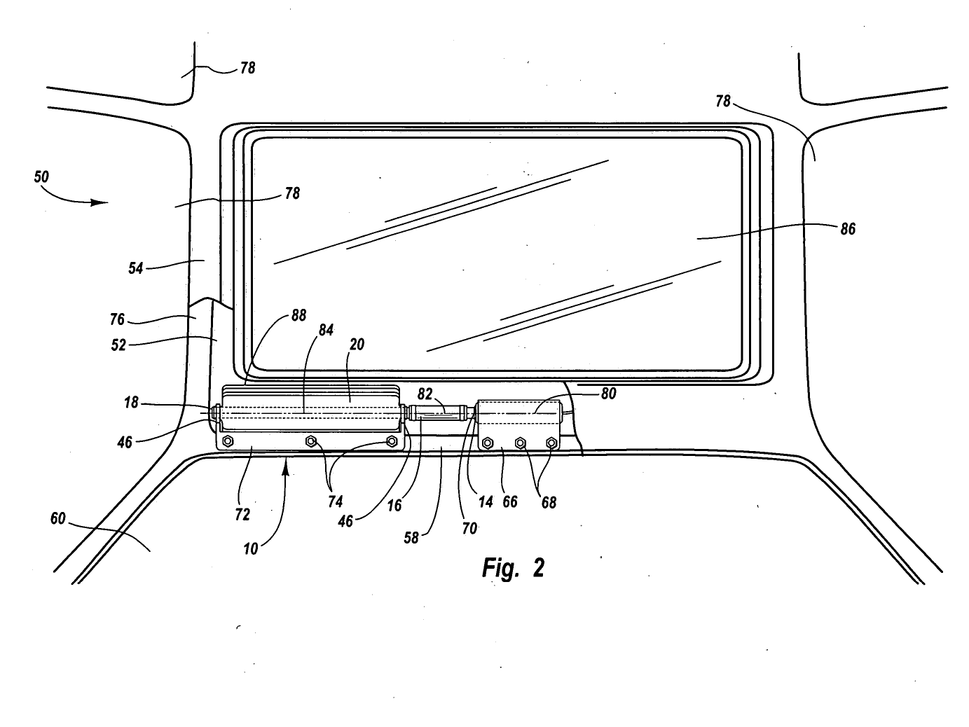

Referring now to FIG. 2, there is shown a bottom view of the first embodiment of the overhead airbag system 10 installed in a vehicle 50. The overhead airbag system 10 is installed between a roof 52 and ceiling liner 54 of the vehicle 50. A portion of the ceiling liner 54 of the vehicle 50 is cutaway to reveal the overhead airbag system 10, which is shown in a stowed condition.

As stated above, the overhead airbag system 10 includes the inflator 14, gas guide 16, tube 18, and cushion 20., The inflator 14 is attached to a header rail 58, which is disposed proximate a windshield 60 of the vehicle 50. As illustrated, a first bracket 66 and a set of bolts 68 are used to secure the inflator 14 to the header rail 58. Of course, alternative techniques, such as heat or pressure welding, brazing, or rivets, may be used to secure the inflator 14 to the header rail 58. The first bracket 66 may be attached to or integrally formed with the inflator casing 70.

As shown in FIG. 2, a second bracket 72 and a set of bolts 74 secure the tube 18 and cushion 20 to the header rail 58. The second bracket 72 is secured to or integrally formed with the clamps 46 that secure the cushion 20 to the tube 18. As with the inflator 14, alternative techniques may be used to secure the tube 18 and cushion 20 to the header rail 58 of the vehicle 50.

The overhead airbag system 10 may be attached to portions of the vehicle 50 besides the header rail 58. For example, the system 10 may be attached to a lateral rail 76 of the vehicle 50. The lateral rail 76 is positioned proximate a side window 78 of the vehicle 50.

As shown, the inflator 14, gas guide 16, and tube 18 are attached to the vehicle 50 in a generally linear configuration. In particular, the longitudinal axes 80, 82, 84 of the inflator 14, gas guide 16, and tube 18 are arranged in a line. However, the term “generally linear configuration,” as used in this application, does not mean that the inflator 14, gas guide 16, and tube 18 are positioned precisely in a line. Thus, there may be some angling of the inflator 14, gas guide 16, and tube 18 relative to each other within the scope of this invention. This generally linear configuration enables the overhead airbag system 10 to fit within the tight confines between a roof 52 and ceiling liner 54 of a vehicle, even when a sun roof 86 is present in the vehicle 50.

The cushion 20 depicted in FIG. 2 is shown in an uninflated, or stowed, condition. The illustrated folds 88 of the cushion 20 are merely exemplary. Those skilled in the art will recognize that there are many different methods of storing the cushion 20 in a compact condition prior to deployment. Moreover, the folding techniques may involve both symmetrical and asymmetrical, and regular or arbitrary compaction methods. The folding techniques influence the deployment sequence of the cushion 20.

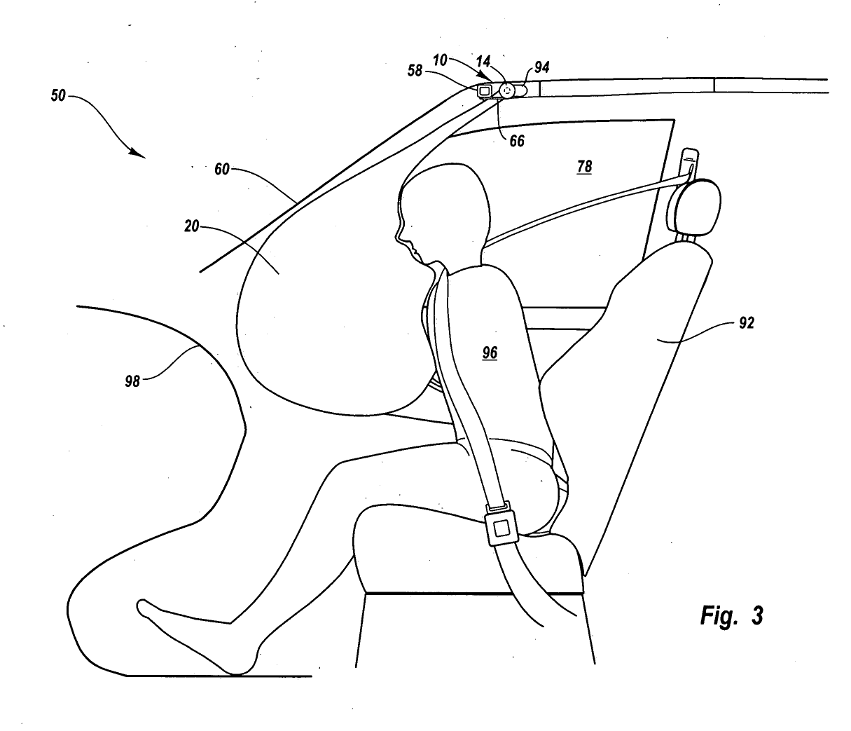

FIG. 3 illustrates a side view of the first embodiment of the overhead airbag system 10 installed in a vehicle 50. As illustrated, the inflator 14 is attached to the header rail 58 using the first bracket 66. The gas guide 16 and tube 18 are obscured by the inflator 14 and thus are not visible in FIG. 3.

As explained previously, the ECU 12 (shown in FIG. 1) initiates the inflation process when it determines that accident conditions exist. In response thereto, inflation gas is injected into the cushion 20. The cushion 20 expands and is propelled out of its storage compartment 94. The cushion 20 shown in FIG. 3 has expanded and deployed to a position immediately in front of the protected occupant 96.

The cushion 20 has deformed in response to the impact of the occupant 96. In its inflated condition, the cushion 20 prevents the occupant from striking the windshield 60 or dashboard 98 and serves to more gradually decelerate the occupant 96 and minimize the risk of injury.

As illustrated, the depicted occupant 96 is seated in the passenger side of the vehicle 50. However, it should be noted that the overhead airbag system 10 can be positioned to protect other occupants of the vehicle 50 and may be used to protect the occupant 96 from striking other portions of the vehicle 50, such as the side window 78.

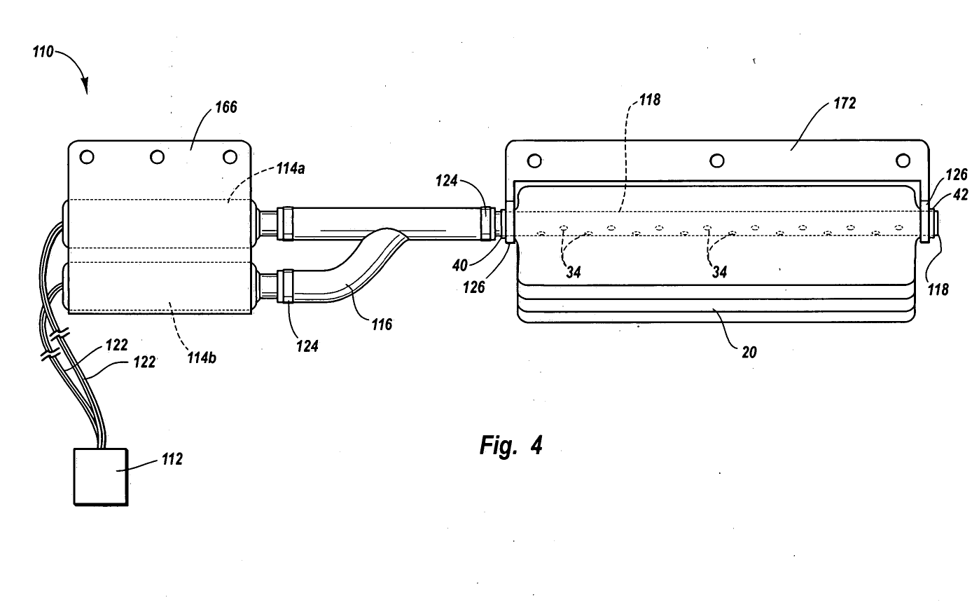

FIG. 4 depicts a perspective view of a second embodiment of the overhead airbag system 110 in a stowed condition. The second embodiment includes an ECU 112, a first and a second inflator 114a-b, a branched gas guide 116, a tube 118, and a cushion 20. As shown, the inflators 114a-b; gas guide 116, and tube 118 are positioned in a generally linear configuration.

The ECU 112 is in communication with the first and second inflator 114a-b through wiring 122. Each of the inflators 114a-b is in fluid communication with the tube 118 through the gas guide 116. As illustrated, clamps 124 are used to secure the gas guide 116 to the inflators 114a-b and tube 118. However, as with the first embodiment, alternative techniques may be used to secure the gas guide 116 to the inflators 114a-b and tube 118.

A pair of clamps 126 secures the tube 118 within the first and second openings 40, 42 of the cushion 20 such that apertures 34 in the tube 118 are positioned within the cushion 20. In an alternative embodiment, the cushion 20 may have only one opening 40 through which the tube 18 is inserted. In contrast to the apertures 34 shown in the first embodiment, which are arranged in a linear pattern, the apertures 34 of the present embodiment are arranged in a zigzag pattern. As stated above, various patterns and shapes of apertures 34 come within the scope of this invention.

A first bracket 166 may be used to attach the two inflators 114a-b to the header rail 58 (shown in FIG. 2) of a vehicle 50. A second bracket 172, which is attached to the clamps 126 that secure the tube 118 within the cushion 20, may be used to affix the tube 118 and cushion 20 to the header rail 58 of the vehicle 50. Because the first and second brackets 166, 172 are not attached together, the inflators 114a-b and tube 118 are independently attachable to the header rail 58. As with the first embodiment, the second embodiment of the overhead airbag system 110 may be attached to the vehicle 50 using other known attachment techniques, such as welding, brazing, or crimping. In addition, the overhead airbag system 110 may be secured to portions of the vehicle 50 besides the header rail 58, such as the lateral rail 76 (shown in FIG. 2).

The second embodiment functions in much the same way as the first embodiment. The ECU 112 transmits a signal to the first and second inflators 114a-b. In response thereto, the first and second inflators 114a-b produce pressurized inflation gas that is transmitted through the gas guide 116 and into the tube 118. The pressurized inflation gas is forced out of the apertures 34 to inflate the cushion 20.

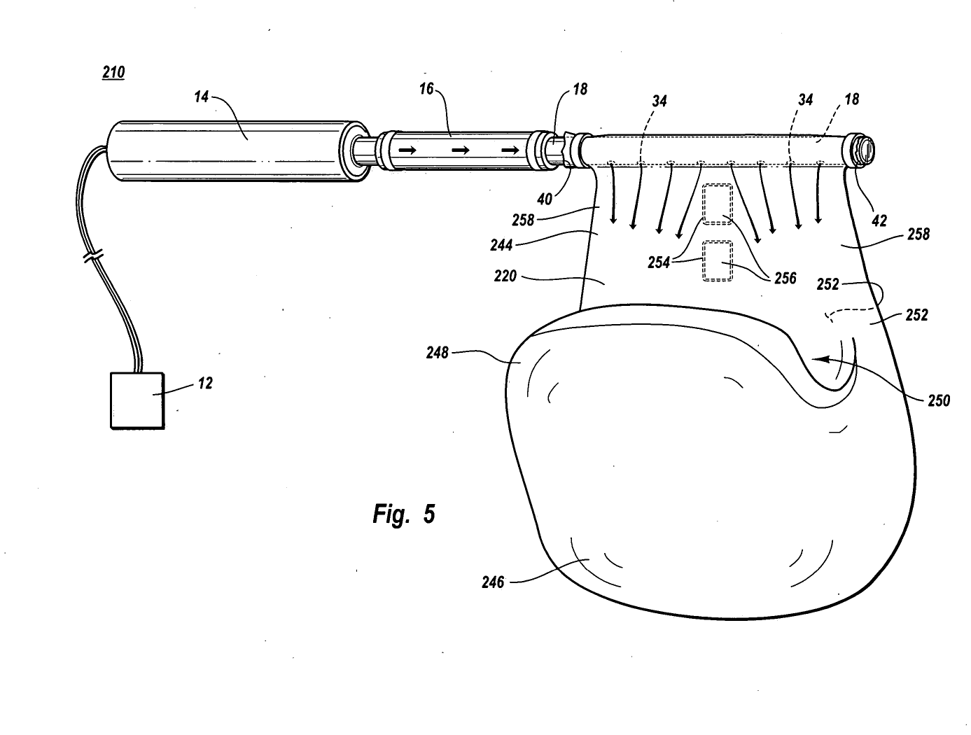

With reference to FIG. 5, there is shown a perspective view of a third embodiment of the overhead airbag system 210 in an inflated condition. The third embodiment of the system 210 is similar to the first embodiment. Accordingly, the third embodiment includes an ECU 12, one or more inflators 14, an optional gas guide 16, and a tube 18. The ECU 12 is in communication with the inflator or inflators 14. The gas guide 16, if used, places each inflator 14 and the tube 18 in fluid communication with each other. Alternatively, each inflator 14 is directly coupled to the tube 18.

In contrast to the first and second embodiments, the third embodiment of the system 210 includes a recessed cushion 220. As illustrated, the recessed cushion 220 has a first and a second opening 40, 42. The tube is secured within the first and second openings 40, 42 such that the apertures 34 of the tube 18 are positioned within the recessed cushion 220. In an alternative embodiment, the recessed cushion 220 includes only the first opening 40 through which the tube 18 enters the recessed cushion 220.

The recessed cushion 220 also includes a gas delivery conduit 244, a main body 246, and a bulge 248 that forms a recess 250. The conduit 244 is a narrow passage through which inflation gas moves from the tube 18 into the main body 246 of the recessed cushion 220. The conduit 244 also acts as a tether to prevent the main body 246 from separating from the tube 18. In addition, the conduit 244 supports the main body 246 and thus assists in ensuring that the main body 246 is properly positioned during inflation.

Opposing sides 252 of the conduit 244 are secured to each other. Various techniques, including stitching 254, rivets, and adhesives, may be used to secure the opposing sides 252 of the conduit 244 to each other.

As illustrated, the conduit 244 includes two discrete narrowed regions 256 that are secured to each other. The pattern, number, and size of the narrowed regions 256 may be varied within the scope of this invention. For example, the narrowed regions 256 may be positioned along the peripheral edges 258 of the recessed cushion 220. The narrowed regions 256 also may be arranged in a checkerboard pattern or various linear, nonlinear or diagonal configurations. A single narrowed region 256 also comes within the scope of this invention. The narrowed region or regions 256 may be embodied in various shapes, such as a triangular, rectangular, round, elliptical, or nonsymmetrical shape.

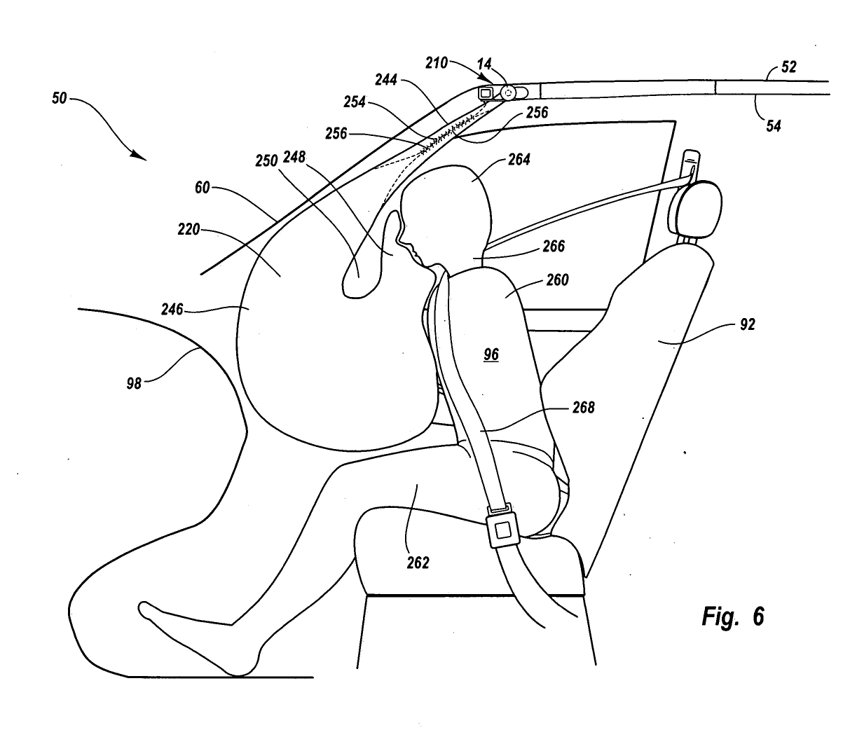

The main body 246 of the recessed cushion 220 is disposed between the conduit 244 and bulge 248 and is thus in fluid communication with the conduit 244 and bulge 248. The main body 246 is shaped to receive the torso and perhaps legs of an occupant 96 in the event of an accident, as will be explained in connection with FIG. 6. When inflated, the main body 246 supports the bulge 248 such that the bulge 248 extends away from the main body 246 at an angle to form the recess 250.

The bulge 248, as illustrated, is shaped as an elongated mound. The bulge 248 may be embodied in other shapes, such as a more rounded or circular shape. The bulge 248 is shaped and positioned to receive the head or neck of an occupant 96 during an accident, as will be discussed below.

Referring now to FIG. 6, a side view of the third embodiment of the overhead airbag system 210 is shown in a vehicle 50. The recessed cushion 220 is shown in an inflated condition. As stated before, the third embodiment includes an inflator 14, gas guide 16, and tube 18 positioned within the recessed cushion 220. In FIG. 6, the tube 18 and gas guide 16 are obscured by the inflator 14 and thus are not illustrated.

The recessed cushion 220 has a gas delivery conduit 244, a main body 246, and a bulge 248 that define the recess 250. As explained above, the conduit 244 includes one or more narrowed regions 256, which are formed using stitching 254 and decrease the size of the conduit 244. Accordingly, the overall volume of the recessed cushion 220 is diminished and the quantity of inflation gas required to inflate the recessed cushion 220 is also diminished. As a result, smaller inflators 14 may be used to inflate the cushion 220, which is a significant advancement given the minimal space available between the roof 52 and ceiling liner 54 of the vehicle 50. The protection provided to the occupant 96 is not jeopardized because the size of the main body 246 and bulge 248 is not diminished by the presence of the narrowed regions 256 in the conduit 244. Moreover, the main body 246 and bulge 248 may inflate more rapidly because a smaller quantity of inflation gas is required to inflate the conduit 244.

The main body 246 receives the impact of the occupant's torso 260 and perhaps legs 262 during loading. Thus, the main body 246 limits the likelihood that the occupant 96 will impact the windshield 60 and dashboard 98 of the vehicle 50. When inflated, the main body 246 also provides support for the bulge 248 such that the bulge 248 extends away from the main body 246 at an angle and is properly positioned during an accident.

As illustrated, the bulge 248 may extend toward the roof 52 of the vehicle 50 to a position generally in front of an occupant 96 and, in particular, generally in front of an occupant's head 264 and neck 266. Therefore, during loading, the bulge 248 receives the occupant's head 264. The main body 246 and bulge 248 also help to retain the occupant 96 in the seat belt 268 and within the vehicle 50 during an accident.

The main body 246, conduit 244, and bulge 248 define a recess 250. When the occupant's head 264 impacts the bulge 248, the recess 250 enables the bulge 248 to move toward the windshield 60 of the vehicle and more gradually decelerate the occupant's head 264 and neck 266. The recess 250 also diminishes the possibility that the occupant's head 264 and neck 266 will contort towards the seat 92, relative to the occupant's torso 260, as the occupant's torso 260 impacts the main body 246 of the recessed cushion 220.

The overhead airbag system thus provides substantial advantages over conventional airbag systems. The overhead airbag system is compact in that the inflator, gas guide, and rigid tube are arranged in a generally linear configuration. Accordingly, the overhead airbag system may be installed in the tight confines between the ceiling liner and roof of a vehicle, even in the presence of a sun or moon roof. In addition, using the rigid tube with apertures, the overhead airbag system provides a simple yet effective mechanism for diffusing and controlling the flow of gas into the cushion. More specifically, the pattern and shape of the apertures in the rigid tube may be modified to alter how gas is distributed within the cushion during inflation. In addition, the recessed cushion provides enhanced cushion positioning during inflation, which results in superior protection to the head and neck of the occupant.

What is claimed is:

1. An airbag system comprising:
an inflator;
an inflatable cushion having an opening;
a rigid tube having a gas exit aperture, the tube being in fluid communication with the inflator, wherein the tube is positioned within the opening such that the aperture is positioned within the cushion, and wherein the tube and inflator are attachable to a vehicle.

2. The airbag system of claim 1, wherein the aperture is positioned on a lateral portion of the tube.

3. The airbag system of claim 1, wherein the tube and inflator are attachable to a header rail of the vehicle in a generally linear configuration.

4. The airbag system of claim 1, wherein the inflator and tube each have a longitudinal axis, and wherein the tube and inflator are attachable to a vehicle such that the longitudinal axes of the inflator and tube are positioned in a generally linear configuration.

5. The airbag system of claim 1, further comprising an additional inflator in fluid communication with the tube.

6. The airbag system of claim 1, wherein the inflator and tube are independently attachable to the vehicle.

7. The airbag system of claim 6, further comprising brackets for attachment of the inflator and tube to the vehicle.

8. The airbag system of claim 1, further comprising a gas guide that transmits inflation gas from the inflator to the tube.

9. The airbag system of claim 8, wherein the inflator, gas guide, and tube are positioned in a generally linear configuration.

10. The airbag system of claim 1, wherein the tube is made from steel.

11. The airbag system of claim 1, further comprising a clamp to secure the tube within the opening of the cushion.

12. The airbag system of claim 1, wherein the cushion comprises a gas delivery conduit, a main body, and a bulge that form a recess.

13. The airbag system of claim 12, wherein the conduit comprises opposing sides of the cushion secured to each other.

14. The airbag system of claim 13, wherein the conduit comprises at least two discrete narrowed regions.

15. The airbag system of claim 12, wherein the bulge is positioned on the cushion to receive a head of an occupant during loading.

16. An overhead airbag system comprising:
an inflator;
an inflatable overhead cushion having a first opening and a second opening;
a rigid tube in fluid communication with the inflator, the tube having a plurality of gas exit apertures, wherein the tube is positioned within the first and second openings such that the apertures are positioned within the cushion, and wherein the tube and inflator are attachable to a vehicle in a generally linear configuration.

17. The overhead airbag system of claim 16, wherein the inflator and tube each have a longitudinal axis, and wherein the tube and inflator are attachable to a vehicle such that the longitudinal axes of the inflator and tube are positioned in a generally linear configuration.

18. The overhead airbag system of claim 16, further comprising an additional inflator in fluid communication with the tube.

19. The overhead airbag system of claim 16, further comprising a gas guide that transmits inflation gas from the inflator to the tube.

20. The overhead airbag system of claim 19, wherein the inflator, gas guide, and tube are positioned in a generally linear configuration.

21. The overhead airbag system of claim 16, wherein the inflator and tube are independently attachable to a vehicle.

22. The overhead airbag system of claim 16, wherein the tube is made from steel.

23. The overhead airbag system of claim 16, wherein the apertures are positioned on a lateral portion of the tube.

24. The overhead airbag system of claim 16, wherein the tube includes a closed end, and wherein the closed end of the tube is positioned within the second opening of the cushion.

25. The overhead airbag system of claim 16, wherein a pair of clamps secures the tube within the cushion.

26. The overhead airbag system of claim 16, wherein the cushion comprises a gas delivery conduit, a main body, and a bulge that form a recess.

27. The overhead airbag system of claim 26, wherein the conduit comprises opposing sides of the cushion secured to each other.

28. The overhead airbag system of claim 26, wherein the bulge is positioned on the cushion to receive a head of an occupant during loading.

29. An overhead airbag system comprising:
an inflator;
an inflatable overhead cushion having a first opening and a second opening;
a rigid tube in fluid communication with the inflator, the tube having a plurality of gas exit apertures, wherein the tube is positioned within the first and second openings such that the apertures are positioned within the cushion, and wherein the tube and inflator are attachable to a header rail of a vehicle.

30. The overhead airbag system of claim 29, wherein the inflator and tube each have a longitudinal axis, and wherein the tube and inflator are attachable to a header rail of a vehicle such that the longitudinal axes of the inflator and tube are positioned in a generally linear configuration.

31. The overhead airbag system of claim 29, further comprising an additional inflator in fluid communication with the tube.

32. The overhead airbag system of claim 29, further comprising a gas guide that transmits inflation gas from the inflator to the tube.

33. The overhead airbag system of claim 29, wherein the inflator, gas guide, and tube are positioned in a generally linear configuration.

34. The overhead airbag system of claim 29, wherein the inflator and tube are independently attachable to a header rail of a vehicle.

35. The overhead airbag system of claim 29, wherein the apertures are positioned on a lateral portion of the tube.

36. The overhead airbag system of claim 29, wherein a pair of clamps secures the tube within the cushion.

37. The overhead airbag system of claim 29, wherein the cushion comprises a gas delivery conduit, a main body, and a bulge that form a recess.

38. The overhead airbag system of claim 37, wherein the conduit comprises opposing sides of the cushion secured to each other.

39. The overhead airbag system of claim 37, wherein the bulge is positioned on the cushion to receive a head of an occupant during loading.
